(19) United States
(12) Patent Application Publication
(10) Pub. No.: US 2022/0237514 A1
(43) Pub. Date: Jul. 28, 2022

(54) Active Data Generation Taking Uncertainties Into Consideration

(71) Applicant: CONTI TEMIC MICROELECTRONIC GMBH, Nürnberg (DE)

(72) Inventor: Christian WIRTH, Niderhoechstadt (DE)

(21) Appl. No.: 17/615,939

(22) PCT Filed: Jun. 2, 2020
(86) PCT No.: PCT/EP2020/065219

§ 371 Date: Dec. 2, 2021

(30) Foreign Application Priority Data
Jun. 4, 2019 (DE) 10 2019 208 121.5

(51) Int. Cl. G06N 20/00

(52) U.S. Cl. CPC G06N 20/00

(57) ABSTRACT

The invention relates to a method for generating data on the basis of data already available having individual annotated data points, the method comprising:
training a first predictor on the basis of data already available;
determining a prediction error of the first predictor for each data point;
training a second predictor to determine an anticipated prediction error of the first predictor and an uncertainty;
determining a data description which maximizes a combination of anticipated prediction error and uncertainty; and
generating data on the basis of the previously determined data description.

The present invention relates to a method for generating data on the basis of data already available having individual annotated data points, to a method for training a predictor with thusly generated data, to a computer program, and to a data carrier.

In the field of machine learning, a predictor is an approximation of a multi-dimensional function.

Determining which data points are to be collected, generated, and used from the entire data realm for an AI (artificial intelligence) method is generally based on a selection made by humans, firm guidelines or happenstance.

Methods of active data generation are necessary, for example, in order to allow for “cooperative learning” with domain experts so as to support the (human) experts' iterative calibration or parameterization tasks. In such scenarios, it is the task of the experts to manually select and evaluate data points (e.g. system parameters) in order to achieve a given optimization goal. However, even with fully automated data collection, methods of active data generation are also necessary.

Methods of “active learning” allow the determination of which data points are to be annotated with target values (e.g. classes, positions or KPIs (key performance indicators)) and are based on an already available set of (unannotated) data. In the article “Counterexample-Guided Data Augmentation” by Tommaso Dreossi, Shromona Ghosh, Xiangyu Yue, Kurt Keutzer, Alberto Sangiovanni-Vincentelli and Sanjit A. Seshia, published in the Proceedings of the Twenty-Seventh International Joint Conference on Artificial Intelligence on pages 2071-2078 in July 2018 (https://doi.org/10.24963/ijcai.2018/286), an alternative method is described which additionally can targetedly determine which data points are to be generated. Additionally, in the article “A Theory of Formal Synthesis via Inductive Learning” by S. Jha and S.A: Seshia, published in Acta Informatica (2017) 54, on page 693 (https://doi.org/10.1007/s00236-017-0294-5), a formal frame concept is described which covers an entire class of concepts without focusing on potential realizations.

Data generation and collection is time consuming, costly, and one-sided, such that it is not sufficient to improve the annotation process.

From the state of the art, a method for generating data is known which maximizes the prediction errors of a predictor in order to generate new data using a data description of the data with the maximized prediction error.

According to the state of the art, the selection of the data points to be generated is the task of an expert. First automated methods for selecting data points to be generated exist, but these only consider which data points are (potentially) difficult to predict for an Al method without taking into account the reliability of the prediction. Therefore, sufficient coverage of the desired or needed data realm cannot be reasonably ensured. Moreover, these known methods are only applicable to 0/1 fields. Such 0/1 fields do not indicate a degree of error, instead only differentiating between error (=1) and no error (=0).

In order to in particular minimize the manual work of the expert, it is therefore of great importance to minimize data generation. Additionally, well selected training data can increase the reliability of the prediction and therefore the quality of the AI method. By using a continuous error standard, an improvement of the estimation of the quality or of the error of the AI method can also be achieved. This way, active, guided data generation can be used which takes both the optimization goal and the coverage of the data realm into consideration.

A method according to the invention therefore comprises the steps of training a first predictor on the basis of data already available, determining a prediction error of the first predictor for each data point, training a second predictor to determine an anticipated prediction error of the first predictor and an uncertainty, determining a data description which maximizes a combination of anticipated prediction error and uncertainty, and generating data on the basis of the previously determined data description.

By data points being targetedly generated which are particularly relevant for the problem at hand and also ensure a sufficient coverage of the data realm, the amount of necessary data can be reduced.

The use of a second predictor allows the method to also be applied in cases in which the first predictor is not invertible or the input space of the predictor cannot be used for data generation.

A further method according to the invention serves to train a predictor with the data generated by the aforementioned method and further comprises the steps of checking if a previously determined quality of the first predictor is achieved and annotating and adding the new data to the data already available.

A computer program according to the invention comprises commands which cause a computer system to carry out one of the aforementioned methods. This has the advantage that the methods can be applied particularly fast and efficiently.

On a data carrier according to the invention, the aforementioned computer program can be stored. This has the advantage that the computer program can be easily transported and reproduced.

Further features of the present invention become apparent from the following description and the attached claims in combination with the figures.

### OVERVIEW OF THE FIGURES

FIG. 1 shows a flow chart of a method for generating data according to the state of the art;

FIG. 2 shows a flow chart of a method according to the invention for generating data;

FIG. 3 shows a flow chart of a method for training a predictor which comprises a method according to the invention for generating data;

FIG. 4 schematically shows an inspection device;

FIG. 5 shows a schematic representation of a vehicle; and

FIG. 6 shows a schematic representation of a data carrier according to the invention.

### DESCRIPTION OF THE FIGURES

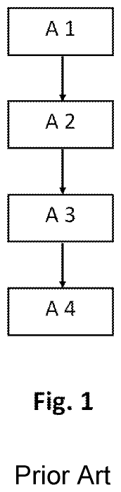

In FIG. 1, a method according to the state of the art for generating data which are, for example, suitable for training a predictor, is shown. Here, in step A1, a predictor is trained on the basis of already annotated data and in step A2, a prediction error for the data is determined. Then, in step A3, the description of a data point which maximizes the prediction error is determined. On the basis of this description, one or several new data points are then generated in step A4.

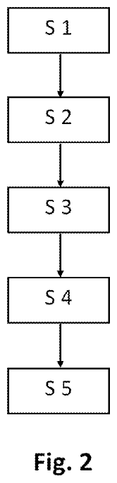

In FIG. 2, a flow chart of a method according to the invention is shown. The method according to the invention begins in step S1 with the training of a first predictor on the basis of annotated data already available. The annotated data in particular consist of data points which are relevant for the training and advantageously also comprise a description. Then, in step S2, a prediction error of the first predictor for each of these data points is determined on the basis of at least a part of the annotated data available.

In step S3, a second predictor is then trained to determine an anticipated prediction error of the first predictor and an uncertainty. In particular, this is done on the basis of the prediction error of the data points of the first predictor. Advantageously, the description of the data points or a description of the data realm is also used to this end.

Then, in step S4, a data description which maximizes a combination of expected prediction error and uncertainty is determined by an algorithm. For example, the upper confidence bound (UCB), which maximizes the sum of expected prediction error and a potentially expanded or condensed uncertainty due to a constant, can be used as a standard for this purpose. For example, by a random generation of data descriptions, the data description which maximizes the standard can be selected this way.

In step S5, new data are then generated based on the data description determined previously in S4. The new data can, for example, at least partially describe a region of the data realm for which the first predictor still makes substantial errors or which is not covered by the first predictor.

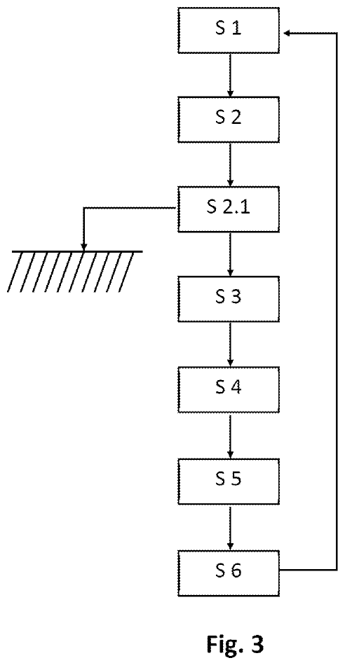

A method for training a predictor using the method according to the invention for generating data comprises the steps S1 to S5 as well as a step S2.1 and a step S6 and is represented in FIG. 3 in the form of a flow chart.

In step S2.1, it is checked whether the quality of the first predictor is sufficient or maximal at this position for the desired application. If so, the method can be concluded here; otherwise, the method is continued in step S3. Here, the quality of the predictor is determined at this position using a suitable standard or another suitable computation rule. For example, the quality of the first predictor can be generated from the arithmetic mean of the prediction errors of the individual data points. The decision regarding how high the quality of the first predictor should or must be is application-specific. As such, when it comes to security-related applications, for example, error probabilities of under 1% are often necessary and with other applications, the consequences (e.g. increased costs) can be estimated by an estimator and a threshold value can be determined up to which the quality is sufficient.

In step S6, the data generated or collected in S5 are annotated and added to the annotated data already available. The method is then continued again in step S1.

The method according to the invention can, for example, be used to generate data for a predictor for predicting the power of an engine on the basis of engine parameters in order to train such a predictor. To this end, annotated data which comprise the parameters of the engine and measured power data are used as a basis (S1 in FIG. 2). The determination of the prediction error (S2 in FIG. 2) in this case comprises the difference between predicted powers and actually measured results.

For the training of the predictor, it is now checked whether the necessary prediction error has already been achieved and, if so, the training method is concluded at this point (S2.1 in FIG. 3). Otherwise, the second predictor, which can show the uncertainties, is trained (S3 in FIG. 2). The second predictor is used for predicting the expected power difference on the basis of the engine parameters. The data realm can in this case comprise various potential regions, in particular the complete spectrum, of the engine parameters and the potential power values.

Subsequently, the data description comprising the maximizing engine parameters relating to the second predictor is determined (S4 in FIG. 2). Generating the new data due to the determined data description (S5 in FIG. 2) can in this case, for example, comprise a new evaluation of the provided engine parameters, in particular further power measurements, for example on an engine test bench. For training the predictor, the new data are then optionally annotated and added to the data already available (S6 in FIG. 3) and the training method is again continued with the training of the first predictor on the basis of the data available which now comprise the data originally available and the new data. Thus, the method can be used to generate a predictor for an engine-driven vehicle, which predictor determines the engine power particularly efficiently or exactly from other engine parameters. This predictor can be installed in a power measuring stand or in a vehicle and simplifies and optimizes the power determination.

The method according to the invention can also be used to generate data for a predictor which can find erroneous positions on images of circuit boards and to train such a predictor. Here, annotated images of known errors or erroneous circuit boards are used as data. The prediction error of the first predictor can then, for example, be a position deviation of predicted errors and known errors on the circuit board. The second predictor can then be trained to predict expected position deviations of errors on the basis of circuit board descriptions. Then, the maximizing circuit description is selected and new data are generated. This can, for example, comprise generating one or several intentionally erroneous circuit boards with different errors and error positions which fulfill the circuit board description. The predictor can, for example, be installed in an inspection device which checks the circuit boards for errors after or during a production process. To this end, the inspection device can be equipped with a data carrier on which at least the predictor, but advantageously also one of the computer programs according to the invention, in order to carry out the invention according to the invention for generating data or for training a predictor, and in particular also the data used to train the predictor are stored, a computing unit which can carry out the predictor, the training of the predictor and the generation of data, as well as a camera for data reception. The inspection device can comprise a communication unit for wired or wireless communication and can also be part of a networked structure, in particular a client/server, master/slave, cloud, internet of things architecture, such that the predictor, the computer programs and/or the data do not need to be locally present on the inspection device, at least not permanently.

The computing unit can control the inspection device and in particular the camera. The computing unit can in particular also be suited to, due to in particular new data which can also be recorded by the camera, perform the method according to the invention for generating data and the training of the predictor.

The inspection device, the predictor, the method for generating data, and the method for training the predictor can also be implemented for other products and production processes, in particular for those which necessitate a low error rate and/or which adaptively and flexibly, and in particular also quickly, adjust to new and changing parameters or errors. This is in particular also the case in the fields of optics production, medicine technology, pharmaceutical production, and chip manufacturing. In this way, such an inspection device can also be installed in the aforementioned power measurement stand or vehicle, in particular for power measurement of the engine, as well as for facial recognition in a vehicle.

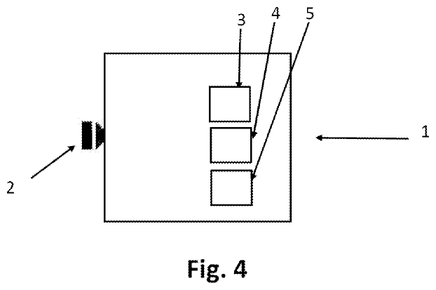

Such an inspection device, which can also be an inspection device according to the invention, is schematically represented in FIG. 4. In this case, the inspection device 1 comprises a sensor apparatus, formed here as a camera 2, a computing unit 3, and a data carrier 4. Furthermore, it can comprise a communication apparatus 5.

Because data can be more targetedly generated by the method for generating data in order to use the data realm as optimally as possible, systems with fewer hardware resources can also be suited to carrying out the method.

The method according to the invention can also be implemented to generate data for facial recognition and train a predictor for said facial recognition, in particular for facial recognition in a vehicle. Here, data points with a relevant annotation, e.g. the position of the face, as well as a description comprising e.g. lighting conditions, vehicle type, type of person, and accessories are provided. Using a partial set of the data points, the first predictor is trained and the remaining data points are used to determine the deviation between the prediction and the annotation. In this way, for the determination of the facial position, the deviation between the predicted and the annotated facial position is then determined on the remaining data points.

With the description of the data points and the deviation between the prediction and the annotation, the second predictor is then trained to predict the deviation between the prediction and the annotation with a certain uncertainty on the basis of the description. The second predictor can, for example, comprise a Gaussian process which determines such a prediction value and an uncertainty, for example in the form of a confidence interval.

Then, (random) descriptions are generated based on the possible values of the description. For these descriptions, the expected prediction error and the uncertainty are determined by the second predictor and those descriptions are selected which deliver a maximum or high values from a combination of the prediction error and uncertainty. Based on the selected descriptions, one or several data points are then generated which correspond to these descriptions. For example, images of faces fulfilling these descriptions can be created using a rendering software. For images generated in such a way, the annotation is advantageously particularly easy to realize. The annotated data points can then be added to the data points and the first predictor can be trained again.

The result is a predictor for determining facial positions in which, due to the presented method, the expected prediction quality for new images is maximized. Additionally, the necessary number of data points (images) has been minimized by the method. In the same way, the predictor or other predictors can be trained to perform expression recognition and other forms of facial recognition in an improved manner.

In particular, the method for generating data, the method for training a predictor, and the predictor itself can be implemented for facial recognition in a vehicle. The vehicle can in this case comprise at least a camera or another sensor in order to generate new data. The vehicle can also comprise a computing unit in order to, in particular also due to in particular new data which can also be recorded by the camera or the sensor, carry out the method according to the invention for generating data, the training of the predictor and the predictor. The vehicle can also comprise a data carrier on which data for training a predictor and computer programs for carrying out the method for generating data, for training a predictor, and of the predictor are stored.

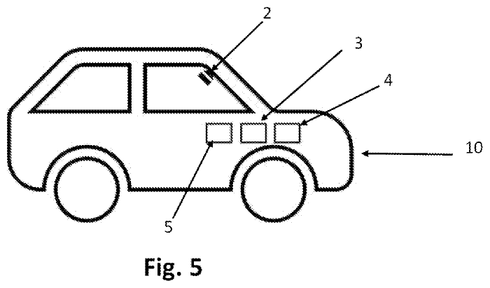

Such a vehicle, which can also be a vehicle according to the invention, is represented in FIG. 5. The vehicle 1 in this case comprises at least a sensor, here in the form of a camera 2, a computing unit 3, and a data carrier 4. Furthermore, the vehicle can also comprise a communication apparatus 5. Here, the camera 2, computing unit 3, data carrier 4 and/or communication unit 5 can also be arranged together in one or several apparatuses. For example, the computing unit 3, the data carrier 4 and/or the communication apparatus 5 can be arranged in the housing of the camera 2.

In the vehicle, the methods according to the invention presented her can also be used for other devices which can function and be improved with trained algorithm and data analysis. In particular, this can be advantageous when it comes to the quickly changing conditions and the amount of data involved in the usage of a vehicle, in particular an autonomous vehicle.

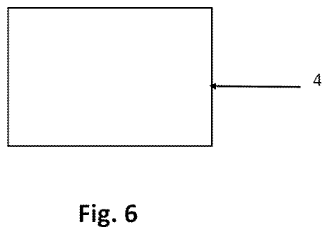

In FIG. 6, a data carrier 4 according to the invention is represented schematically. On the data carrier 4, at least one of the computer programs according to the invention in order to carry out the method according to the invention for generating data or training a predictor, but in particular also the data used to train the predictor and the predictor itself can be stored.

### LIST OF REFERENCE NUMERALS

A1-A5 method step

S1-S6, S2.1 method step

1 inspection device

2 camera

3 computing unit

4 data carrier

5 communication unit

10 vehicle

1. A method for generating data on the basis of data already available having individual annotated data points, the method comprising:
training (S1) a first predictor on the basis of data already available;
determining (S2) a prediction error of the first predictor for each data point;
training (S3) a second predictor to determine an anticipated prediction error of the first predictor and an uncertainty;
determining (S4) a data description which maximizes a combination of anticipated prediction error and uncertainty; and
generating (S5) data on the basis of the previously determined data description.

2. The method for training a predictor with data generated by a method according to claim 1, further comprising:
checking (S2.1) if a previously determined quality of the first predictor is achieved; and
annotating and adding (S6) the new data to the data already available.

3. A computer program comprising commands which cause a computer system to carry out the method according to claim 1.

4. A data carrier on which the computer program according to claim 3 is stored.

5. An inspection device (1) comprising a sensor apparatus (2), a computing unit (3) and the data carrier (4) according to claim 4.

6. The inspection device according to claim 5 comprising a communication apparatus (5).
